(19) United States
(12) Patent Application Publication
(10) Pub. No.: US 2025/0217776 A1
(43) Pub. Date: Jul. 3, 2025

(54) MAINTENANCE RESERVATION SYSTEM, MAINTENANCE RESERVATION SERVER, AND NON-TRANSITORY COMPUTER-READABLE STORAGE MEDIUM

(71) Applicant: Mitsubishi Electric Corporation, Tokyo (JP)

(72) Inventors: Toshiyuki KURIYAMA, Tokyo (JP); Hirotoshi YANO, Tokyo (JP)

(21) Appl. No.: 18/718,632

(22) PCT Filed: Apr. 6, 2022
(86) PCT No.: PCT/JP2022/017141

§ 371 Date: Jun. 11, 2024

(51) Int. Cl. G06Q 10/20; G06Q 10/1093

(52) U.S. Cl. CPC G06Q 10/20; G06Q 10/1097

(57) ABSTRACT

A maintenance reservation system according to a first aspect includes: an equipment information acquisition unit configured to acquire equipment information including information about equipment; a maintenance contractor information acquisition unit configured to acquire maintenance contractor information including information about maintenance contractors who provide maintenance services on the basis of information transmitted from maintenance contractor terminals; a reservation information acquisition unit configured to acquire reservation information including desired conditions for the maintenance services on the basis of information transmitted from a user terminal; a processing unit configured to select maintenance contractor candidates on the basis of the equipment information and the maintenance contractor information, and narrow down the candidates on the basis of the desired conditions and the maintenance contractor information corresponding to the maintenance contractors included in the candidates; and a notification unit configured to notify the user terminal of the candidates narrowed down by the processing unit.

### CROSS-REFERENCE TO RELATED APPLICATION

This application is a U.S. National Stage Application of International Application No. PCT/JP2022/017141 filed Apr. 6, 2022, the contents of which are incorporated herein by reference.

### TECHNICAL FIELD

The present disclosure relates to a maintenance reservation system, a maintenance reservation server, and a non-transitory computer-readable storage medium.

### BACKGROUND

Conventionally, for example, various types of services are provided for the maintenance of air conditioners. For example, when an air conditioner used by a user has failed, the user requests a manufacturer to perform maintenance, and the manufacturer or a maintenance contractor other than the manufacturer provides a maintenance service such as repairing the air conditioner. Examples of contractors that provide maintenance services include authorized shops of manufacturers and contractors other than the manufacturers, and the number of contractors is increasing. Therefore, technology for enabling a user to send a maintenance service request to a maintenance contractor has been proposed.

For example, in a maintenance service system described in Patent Document 1, when a user terminal accesses a maintenance reception center, a maintenance reception center terminal transmits a failure information table and a maintenance worker management table to the user terminal. The user terminal decides on failure information and a name of a maintenance worker and transmits the failure information and the name of the maintenance worker to the maintenance reception center terminal. Thereby, the maintenance worker can cope with a failure.

For example, in a facility maintenance work support method described in Patent Document 2, a customer transmits to a server, content of a maintenance service for a facility desired by the customer and facility information. The server analyzes the content of the maintenance service and the facility information to determine whether a condition for performing maintenance is satisfied, and performs the selection of a maintenance worker and the like.

### PATENT DOCUMENT

[Patent Document 1] Japanese Unexamined Patent Application, First Publication No. 2002-149863

[Patent Document 2] Japanese Unexamined Patent Application, First Publication No. 2003-150732

In the technologies described in Patent Document 1 and Patent Document 2 described above, information such as failure information, a name of a maintenance worker, content of a maintenance service, and facility information is transmitted from a user terminal. However, a process of designating user-desired content in detail and selecting a maintenance contractor according to a designated desire is not performed. Moreover, it is desirable that the maintenance contractor has a mechanism for acquiring repeat customers by providing a service that is a specialty of the maintenance contractor.

### SUMMARY

The present disclosure has been made to solve the above-described problems and an objective of the present disclosure is to provide a maintenance reservation system, a maintenance reservation server, and a maintenance reservation method for enabling a maintenance contractor to be selected according to a user's desire. Moreover, an objective of the present disclosure is to provide a maintenance reservation system, a maintenance reservation server, a maintenance reservation method, and a non-transitory computer-readable storage medium for enabling repeat customers to be acquired by providing a service that is a specialty of a maintenance contractor.

A maintenance reservation system according to a first aspect includes: an equipment information acquisition unit configured to acquire equipment information including information about equipment; a maintenance contractor information acquisition unit configured to acquire maintenance contractor information including information about maintenance contractors who provide maintenance services on the basis of information transmitted from maintenance contractor terminals; a reservation information acquisition unit configured to acquire reservation information including desired conditions for the maintenance services on the basis of information transmitted from a user terminal; a processing unit configured to select maintenance contractor candidates on the basis of the equipment information and the maintenance contractor information, and narrow down the candidates on the basis of the desired conditions and the maintenance contractor information corresponding to the maintenance contractors included in the candidates; and a notification unit configured to notify the user terminal of the candidates narrowed down by the processing unit.

A maintenance reservation method according to a second aspect includes steps of: acquiring equipment information including information about equipment; acquiring maintenance contractor information including information about maintenance contractors who provide maintenance services on the basis of information transmitted from maintenance contractor terminals; acquiring reservation information including desired conditions for the maintenance services on the basis of information transmitted from a user terminal; selecting maintenance contractor candidates on the basis of the equipment information and the maintenance contractor information; narrowing down the candidates on the basis of the desired conditions and the maintenance contractor information corresponding to the maintenance contractors included in the candidates; and notifying the user terminal of the candidates narrowed down.

A maintenance reservation server according to a third aspect includes: an acquisition unit configured to acquire information about maintenance contractors who provide maintenance services on the basis of information transmitted from maintenance contractor terminals and reservation information including desired conditions related to work other than maintenance of equipment on the basis of information transmitted from a user terminal; a processing unit configured to select maintenance contractor candidates on the basis of equipment information including information about the equipment and first available work of the maintenance contractor related to maintenance work for the equipment, and narrow down the candidates on the basis of the desired conditions and second available work of the maintenance contractor related to work other than the maintenance of the equipment; and a notification unit configured to notify the user terminal of the candidates narrowed down by the processing unit.

A maintenance reservation method according to a fourth aspect includes steps of: acquiring information about maintenance contractors who provide maintenance services on the basis of information transmitted from maintenance contractor terminals and reservation information including desired conditions related to work other than maintenance of equipment on the basis of information transmitted from a user terminal; selecting maintenance contractor candidates on the basis of equipment information including information about the equipment and first available work of the maintenance contractor related to maintenance work for the equipment, and narrowing down the candidates on the basis of the desired conditions and second available work of the maintenance contractor related to work other than the maintenance of the equipment; and notifying the user terminal of the candidates narrowed down.

A non-transitory computer-readable storage medium according to a fifth aspect stores a program causing a computer to execute steps of: acquiring information about maintenance contractors who provide maintenance services on the basis of information transmitted from maintenance contractor terminals and reservation information including desired conditions related to work other than maintenance of equipment on the basis of information transmitted from a user terminal; selecting maintenance contractor candidates on the basis of equipment information including information about the equipment and first available work of the maintenance contractor related to maintenance work for the equipment, and narrowing down the candidates on the basis of the desired conditions and second available work of the maintenance contractor related to work other than the maintenance of the equipment; and notifying the user terminal of the candidates narrowed down.

According to the present disclosure, a maintenance contractor can be selected according to a user's desire. Moreover, according to the present disclosure, it is possible to acquire repeat customers by providing a service that is a specialty of a maintenance contractor.

### BRIEF DESCRIPTION OF THE DRAWINGS

FIG. 1 is a block diagram showing an example of a maintenance reservation system according to a first embodiment.

FIG. 2 is a block diagram showing an example of the maintenance reservation system in the first embodiment.

FIG. 3 is a diagram showing an example of a screen to which maintenance contractor information is input by a maintenance contractor.

FIG. 4 is a diagram showing an example of a screen for inputting maintenance worker information.

FIG. 5 is a diagram showing an example of error information.

FIG. 6 is a diagram showing an example of sensor data.

FIG. 7 is a diagram showing an example of a screen for inputting reservation information.

FIG. 8 is a diagram showing an example of an operation procedure according to the first embodiment.

FIG. 9 is a block diagram showing an example of a maintenance reservation system according to a second embodiment.

FIG. 10 is a diagram showing an example of a screen for inputting reservation information in a third embodiment.

### DETAILED DESCRIPTION

Hereinafter, embodiments of the present disclosure will be described with reference to the drawings. In addition, the scope of the present disclosure is not limited to the following embodiments, and any modification is possible within the scope of the technical idea of the present disclosure. Moreover, in the following drawings, in order to make each configuration easier to understand, the scale and number and the like in each structure may be different from the scale and number and the like in the actual structure.

### (Configuration of Maintenance Reservation System)

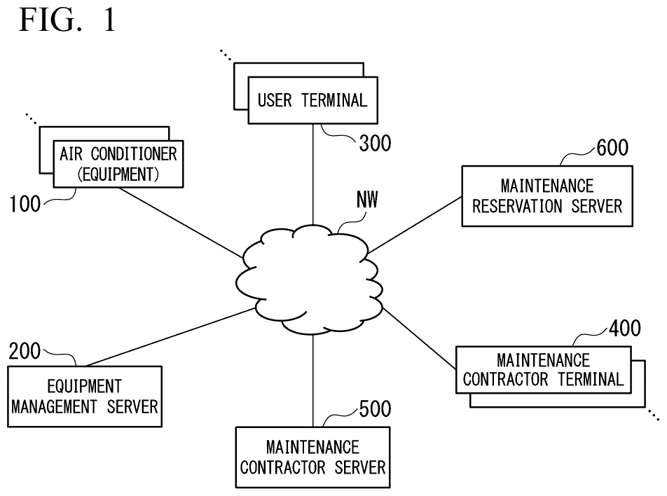

FIG. 1 is a block diagram showing an example of a maintenance reservation system according to a first embodiment. The maintenance reservation system includes, for example, one or more air conditioners 100, an equipment management server 200, one or more user terminals 300, a plurality of maintenance contractor terminals 400, a maintenance contractor server 500, and a maintenance reservation server 600. The air conditioner 100 is connected to a network NW such as the Internet via communication equipment such as a router. The communication equipment may be, for example, communication equipment retrofitted to the air conditioner 100 such as an access point installed in a house. The equipment management server 200, the user terminal 300, the maintenance contractor terminal 400, the maintenance contractor server 500, and the maintenance reservation server 600 have a communication interface (not shown) such as a network interface card (NIC) and a wireless communication module for connecting to the network NW. In addition, in the following description, a user of the air conditioner 100 is referred to as a “user,” a company who provides a service such as maintenance of the air conditioner 100 as a business is referred to as a “maintenance contractor,” and a person who actually performs maintenance work is also referred to as a “maintenance worker.”

In addition, although the equipment management server 200, the maintenance contractor server 500, and the maintenance reservation server 600 are provided as servers in the embodiment, the present disclosure is not limited thereto. Functions of the equipment management server 200, the maintenance contractor server 500, and the maintenance reservation server 600 may be integrated into one server. Functions of the equipment management server 200, the maintenance contractor server 500, and the maintenance reservation server 600 may be distributed in a form different from the embodiment. Some functions of the equipment management server 200, the maintenance contractor server 500, and the maintenance reservation server 600 may be provided in the user terminal 300 or the maintenance contractor terminal 400.

The air conditioner 100 is an example of equipment serving as a maintenance target. The air conditioner 100 includes, for example, an outdoor unit and an indoor unit connected to each other by a circulation path portion through which a refrigerant circulates. The air conditioner 100 adjusts a temperature of indoor air by exchanging heat between the refrigerant flowing through the circulation path portion and the air in a room where the indoor unit is installed.

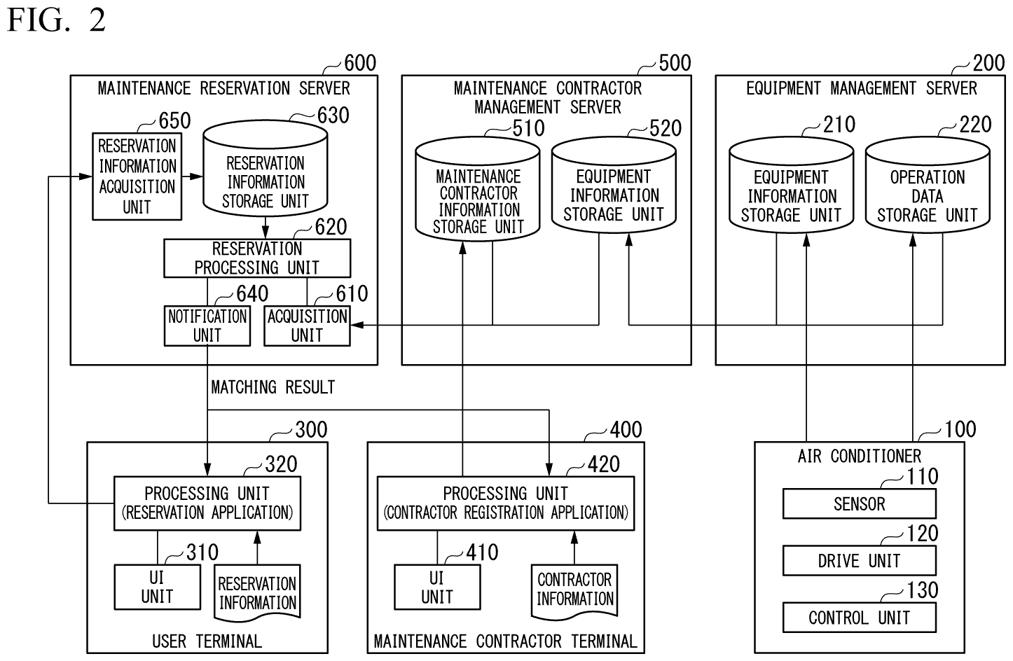

FIG. 2 is a block diagram showing an example of the maintenance reservation system in the first embodiment. The air conditioner 100 includes, for example, a sensor 110, a drive unit 120, and a control unit 130. The sensor 110 includes a sensor for detecting an ambient temperature, a room temperature, a refrigerant temperature, and the like of the air conditioner 100, and a sensor for detecting a drive state and the like of the air conditioner 100. The drive unit 120 includes drive parts such as a fan, a compressor, and a valve in outdoor and indoor units. The control unit 130 controls the drive unit 120 on the basis of a command value received from a remote control and sensor data detected by the sensor 110. Moreover, the control unit 130 transmits to the equipment management server 200, equipment information indicating a type of the air conditioner 100 and the like, sensor data, operation data of the air conditioner 100, error information based on the sensor data, and the like. The operation data of the air conditioner 100 is information including, for example, an operation mode such as heating, cooling, or dehumidification, an operation time, and the like.

The equipment management server 200 is an information processing device such as a server device that performs a process of managing the air conditioner 100. The equipment management server 200 includes, for example, an equipment information storage unit 210 and an operation data storage unit 220. The equipment information storage unit 210 stores equipment information of the air conditioner 100 that is a management target in the maintenance reservation system. The operation data storage unit 220 stores operation data, sensor data, and error information of the air conditioner 100 that is the management target in the maintenance reservation system. The equipment management server 200 transmits to the maintenance contractor server 500, the stored equipment information, operation data, sensor data, and error information as necessary.

The user terminal 300 is a smartphone, a personal computer, or the like operated by a user who uses the air conditioner 100. The user terminal 300 includes, for example, a user interface unit (UI unit) 310 and a processing unit 320. The user interface unit 310 includes, for example, a display unit, an operation unit, and the like. The processing unit 320 is implemented by, for example, a processor such as a central processing unit (CPU) executing a program stored in a program memory. Software, firmware, or a combination of software and firmware is described as a program, and the program is stored in the program memory. The processing unit 320 performs various types of processes in accordance with a reservation application for performing a process of reserving a maintenance service. The processing unit 320 generates reservation information including a user's request and transmits the generated reservation information to the maintenance reservation server 600.

The maintenance contractor terminal 400 is a smartphone, a personal computer, or the like operated by the maintenance contractor. The maintenance contractor terminal 400 includes, for example, a user interface unit (UI unit) 410 and a processing unit 420. The user interface unit 410 includes, for example, a display unit, an operation unit, and the like. The processing unit 420 is implemented by, for example, a processor such as a CPU executing a program stored in a program memory. Software, firmware, or a combination of software and firmware is described as a program, and the program is stored in the program memory. The processing unit 420 performs various types of processes in accordance with a contractor registration application for performing a process of registering the maintenance contractor in the maintenance contractor server 500.

The maintenance contractor server 500 is an information processing device such as a server device that performs a process of managing a maintenance contractor. The maintenance contractor server 500 includes, for example, a maintenance contractor information storage unit 510 and an equipment information storage unit 520. The maintenance contractor information storage unit 510 stores maintenance contractor information on the basis of information transmitted from the maintenance contractor terminal 400. The maintenance contractor information includes information about the maintenance contractor based on the information transmitted from the maintenance contractor terminal 400. The equipment information storage unit 520 stores equipment information, operation data, sensor data, error information, and the like of the air conditioner 100 serving as a maintenance service target. The maintenance contractor server 500 transmits the stored maintenance contractor information, equipment information, operation data, sensor data, and error information to the maintenance reservation server 600 as necessary.

The maintenance reservation server 600 is an information processing device such as a server device that performs a management process of a maintenance contractor on the basis of a user's request. The maintenance reservation server 600 includes, for example, an acquisition unit 610, a reservation processing unit 620, a reservation information storage unit 630, a notification unit 640, and a reservation information acquisition unit 650. The acquisition unit 610, the reservation processing unit 620, the notification unit 640, and the reservation information acquisition unit 650 are implemented by, for example, a processor such as a CPU executing a program stored in a program memory. The acquisition unit 610 acquires equipment information, operation data, sensor data, error information, and maintenance contractor information. The reservation processing unit 620 performs a process of selecting candidates for the maintenance contractor on the basis of the equipment information and the maintenance contractor information and narrowing down the candidates on the basis of the maintenance contractor information corresponding to the maintenance contractor included in the candidates and the reservation information. The notification unit 640 notifies the user terminal 300 of the candidates narrowed down by the reservation processing unit 620. The reservation information acquisition unit 650 acquires reservation information from the user and transmits the acquired reservation information to the reservation information storage unit 630. The reservation information storage unit 630 stores the reservation information transmitted by the reservation information acquisition unit 650.

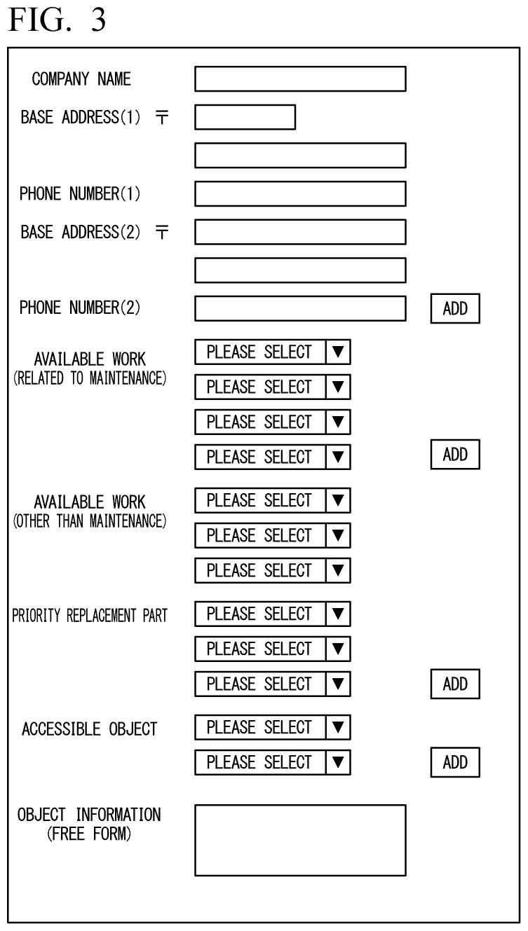

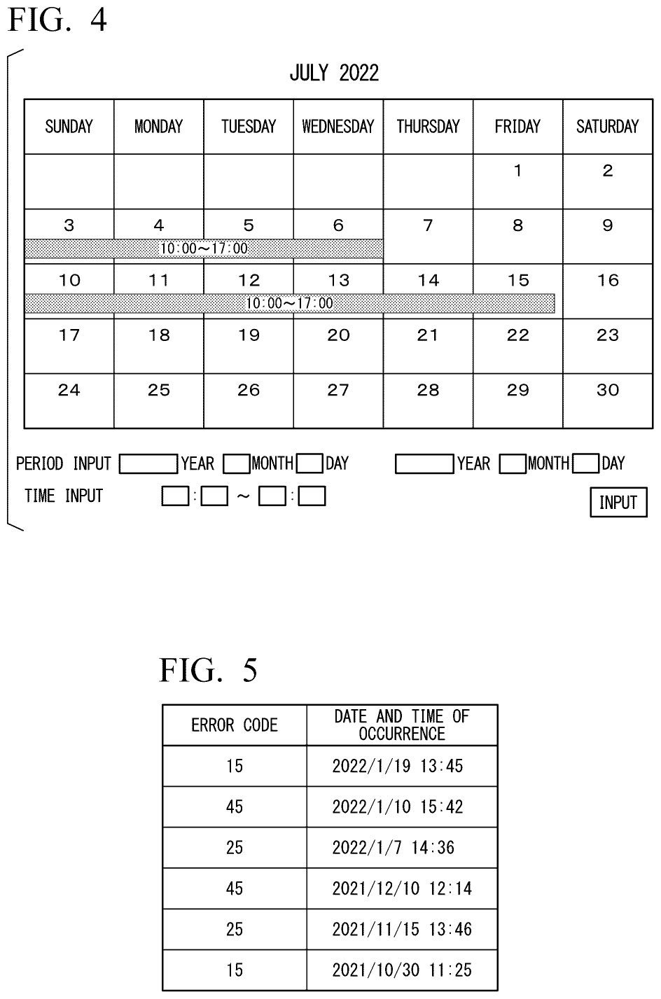

FIG. 3 is a diagram showing an example of a screen to which maintenance contractor information is input by the maintenance contractor. FIG. 4 is a diagram showing an example of a screen for inputting maintenance worker information. The maintenance worker information is unfixed information such as available maintenance schedule information of a maintenance worker. On a screen for inputting the maintenance contractor information, a field for inputting fixed information about the maintenance contractor is provided. The screen for inputting the maintenance contractor information includes, for example, a company name input field, a base address input field, a phone number input field, a maintenance-related available work input field, a field for inputting available work other than maintenance, a priority replacement part input field, an accessible object input field, and an object information input field. The maintenance contractor terminal 400 generates first work information about maintenance work for the air conditioner 100 on the basis of an input operation for the maintenance-related available work input field. The maintenance-related available work is, for example, first available work such as installation, inspection, measurement, repair, part replacement, and removal of the air conditioner 100. The maintenance contractor terminal 400 generates second work information about work other than the maintenance for the air conditioner 100 on the basis of an input operation for the field for inputting available work other than the maintenance. The available work other than the maintenance is information indicating second available work other than the maintenance based on a user's request. The available work other than the maintenance includes, for example, other optional services such as cleaning of the air conditioner 100, housekeeping services, advice on various types of usage methods, a network setting agency, and waste collection. The optional services may include conditions such as a gender of the worker, whether or not the maintenance contractor can access a women's dormitory, whether or not a level of skill is sufficient, whether or not the maintenance contractor can access high places, whether or not the maintenance contractor can access equipment installed on a roof, and whether or not the maintenance contractor has a sufficient track record. The priority replacement part is, for example, a name or the like of a part that is a specialty of the maintenance contractor. In addition, the maintenance contractor terminal 400 is not limited to the priority replacement part and it is only necessary to receive an input of priority information indicating the work to be performed by the maintenance contractor in priority. The accessible object indicates, for example, a type of object capable of being accessed by the maintenance contractor. The object information is, for example, information about objects with which the maintenance contractor is experienced. The maintenance contractor terminal 400 generates the maintenance contractor information on the basis of information input to the input fields shown in FIGS. 3 and 4 and transmits the generated maintenance contractor information to the maintenance contractor server 500. The maintenance contractor server 500 registers the maintenance contractor by storing the received maintenance contractor information in the maintenance contractor information storage unit 510.

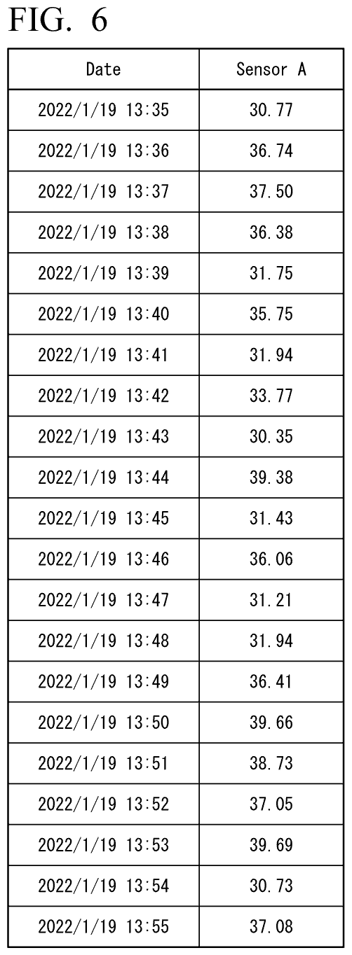

FIG. 5 is a diagram showing an example of error information. FIG. 6 is a diagram showing an example of sensor data. The error information is, for example, information in which an error code is associated with occurrence time information indicating the time at which an error occurred. An error code is, for example, information corresponding to a symptom detected in the air conditioner 100. The air conditioner 100 determines whether or not conditions for generating error information have been satisfied. The conditions for generating error information are, for example, a condition that the sensor data detected by the sensor 110 exceeds a threshold value and a condition that the drive state of the drive unit 120 satisfies a setting condition. The error information is transmitted from the air conditioner 100 to the equipment management server 200 together with the sensor data corresponding to the error code. For example, as shown in FIG. 6, the air conditioner 100 acquires sensor data sampled every minute during 10 minutes after the occurrence of the error as sensor data corresponding to the error code “15” that occurred at 13:45 on 2022 Jan. 19 shown in FIG. 5 and transmits the acquired sensor data to the equipment management server 200 as the sensor data.

Thereby, the air conditioner 100 can transmit equipment information, error information, sensor data, and the like to the equipment management server 200. The equipment management server 200 may select information necessary for maintenance from the information received from the air conditioner 100. For example, the equipment management server 200 selects equipment information such as sensor data, operation data, and model information of the air conditioner 100 linked to an error code and transmits the selected information to the maintenance contractor server 500.

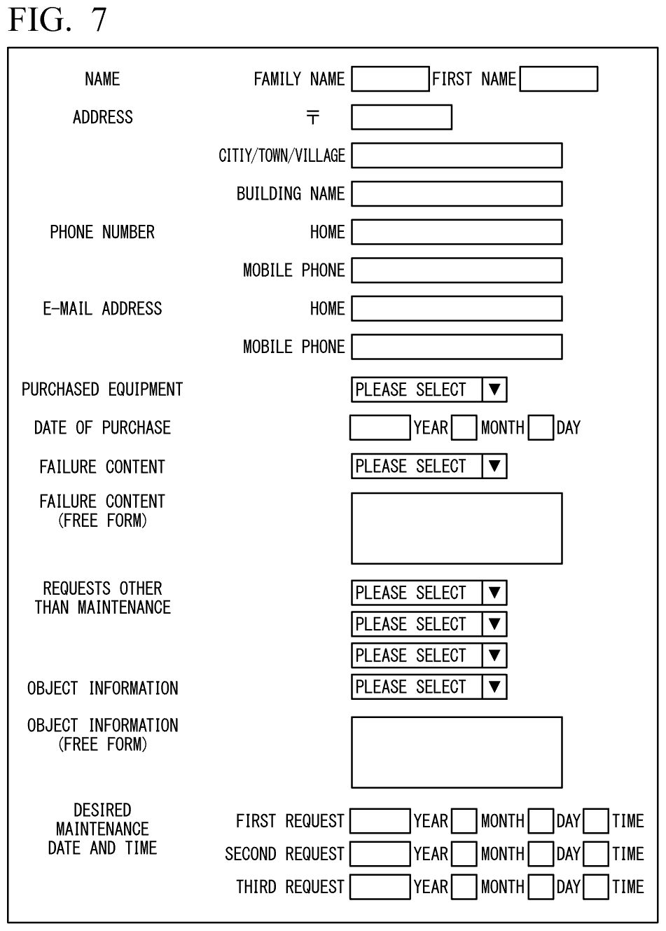

FIG. 7 is a diagram showing an example of a screen for inputting reservation information. The screen for inputting reservation information includes, for example, a name input field, an address input field, a phone number input field, an e-mail address input field, a purchased equipment input field, a purchase date input field, a failure content input field, a field for inputting desired work other than maintenance, an object information input field, and a desired date and time input field. In the purchased equipment input field, for example, information such as a model or serial number of the air conditioner 100 is input. For example, information indicating a first desired condition related to the maintenance work for the air conditioner 100 such as a symptom recognized by the user or an error code displayed on the remote control or the like is input to the failure content input field. Information corresponding to the available work other than the maintenance input by the maintenance contractor is input to the field for inputting desired work other than the maintenance. For example, information indicating a second desired condition for the user to limit the maintenance contractor with respect to other optional services such as cleaning of the air conditioner 100, housekeeping service, advice on various types of usage methods, network setting agency, and waste collection is input to the field for inputting desired work other than the maintenance. Information that does not correspond to the available work other than the maintenance input by the maintenance contractor may be input to the field for inputting desired work other than the maintenance. For example, information indicating a second desired condition of a building such as a women's dormitory in which entering and leaving are restricted, a skill level of the maintenance worker desired by the user, work content, special environment objects such as outdoor wall hangings or high places, or the like may be input to the field for inputting desired work other than the maintenance. For example, information of a type of building such as a detached house or a condominium, the number of floors on which the air conditioner 100 is installed, and the like is input to the object information input field. The user terminal 300 generates reservation information including a first request for requesting maintenance of the air conditioner 100 and a second request for requesting work other than the maintenance of the air conditioner 100 on the basis of the information input to the input field and transmits the generated reservation information to the maintenance reservation server 600.

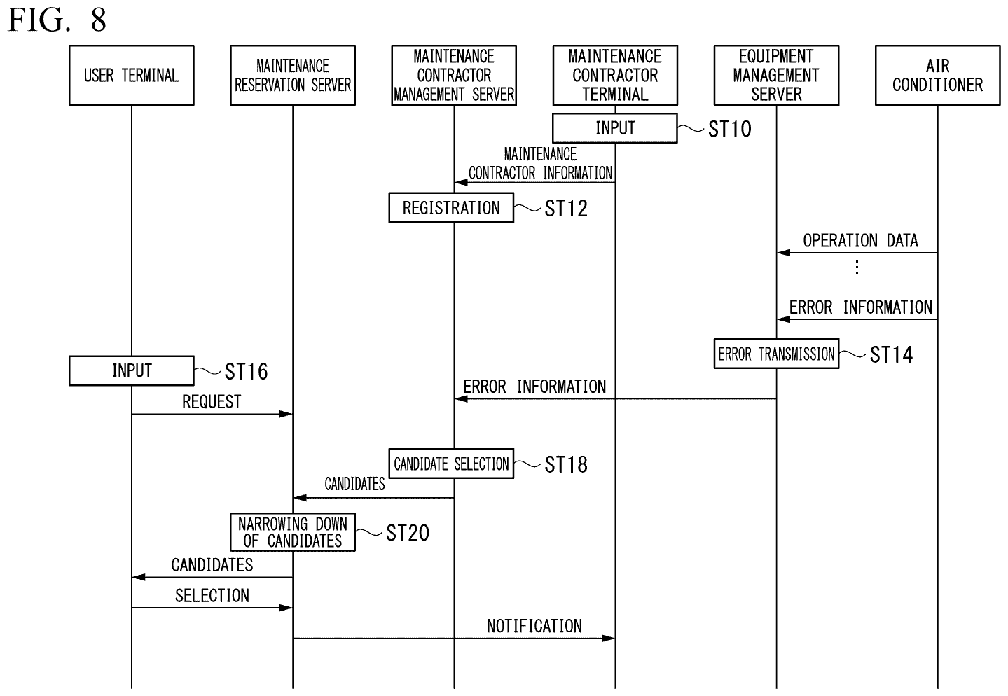

FIG. 8 is a diagram showing an example of an operation procedure according to the above-described first embodiment. The maintenance contractor terminal 400 transmits maintenance contractor information to the maintenance contractor server 500 on the basis of an input of the maintenance contractor (step ST10). The maintenance contractor server 500 registers the maintenance contractor by receiving the maintenance contractor information and storing the received maintenance contractor information in the maintenance contractor information storage unit 510 (step ST12). The air conditioner 100 transmits equipment information, operation data, and sensor data to the equipment management server 200, and the equipment management server 200 stores the equipment information, the operation data, and the sensor data.

When the air conditioner 100 has detected an error, the air conditioner 100 transmits the error information to the equipment management server 200. In response to the reception of the error information from the air conditioner 100, the equipment management server 200 extracts the equipment information and the sensor data associated with the error information from the equipment information storage unit 210 and the operation data storage unit 220, and transmits the equipment information and the sensor data to the maintenance contractor server 500 (step ST14).

The maintenance contractor server 500 selects candidates for the maintenance contractor by comparing the equipment information and error information received from the equipment management server 200 with the maintenance contractor information stored in the maintenance contractor information storage unit 510 (step ST18). For example, the maintenance contractor server 500 may create a candidate list of maintenance contractors that can handle an installation area of the air conditioner 100 and narrow down maintenance contractors by excluding a maintenance contractor from the candidate list when a model identified with the equipment information received from the equipment management server 200 is a model outside of an available range of the maintenance contractor. The maintenance contractor server 500 may exclude a maintenance contractor from the candidate list, for example, when work for coping with the error identified with the error code is work outside of the available range of the maintenance contractor. The maintenance contractor server 500 transmits to the maintenance reservation server 600, the maintenance contractor information for the maintenance contractor selected as a candidate. On the other hand, the user terminal 300 transmits reservation information including the user's request to the maintenance reservation server 600 by receiving an input of the user (step ST16). Thereby, the maintenance reservation system can prevent the trouble of having to make a reservation again when it is found that the maintenance contractor cannot satisfy the user's desire after the user reserves the maintenance.

The maintenance reservation server 600 narrows down the candidates for the maintenance contractor by comparing the maintenance contractor information corresponding to the maintenance contractor included in the candidates with the reservation information (step ST20). The maintenance reservation server 600 narrows down the maintenance contractors capable of providing maintenance at a desired date and time by comparing the desired date and time included in the reservation information with the available maintenance schedule included in the maintenance contractor information. Furthermore, the maintenance reservation server 600 compares desired work other than the maintenance included in the reservation information with available work other than the maintenance included in the maintenance contractor information and narrows down the maintenance contractors that can handle the desired work other than the maintenance.

The maintenance reservation server 600 notifies the user of the candidates by transmitting to the user terminal 300, information for displaying a list of maintenance contractors included in the narrowed-down candidates. The user terminal 300 can allow the user to select a desired maintenance contractor by displaying a list of candidates. When the user terminal 300 has received an operation for selecting a maintenance contractor, the user terminal 300 transmits information based on the selected operation to the maintenance reservation server 600. The maintenance reservation server 600 notifies the maintenance contractor terminal 400 corresponding to the maintenance contractor selected by the user that the maintenance contractor has been selected.

In addition, the maintenance reservation server 600 may compare a maintenance request included in the reservation information with priority information indicating priority work to be performed by the maintenance contractor, and preferentially select the maintenance contractor corresponding to the maintenance contractor information including the priority information when the maintenance request matches the priority information. For example, when a compressor of the air conditioner 100 has failed, the maintenance reservation server 600 can preferentially assign a maintenance contractor that focuses on the compressor of the air conditioner 100.

For example, the maintenance reservation server 600 may determine that the maintenance contractor is close to the desire of the user as the number of available works other than the maintenance included in the maintenance contractor information matching the desire other than the maintenance included in the reservation information increases. The maintenance reservation server 600 sorts the maintenance contractors according to the number of matches between the desire other than the maintenance included in the reservation information and the available work other than the maintenance included in the maintenance contractor information. The maintenance reservation server 600 transmits to the user terminal 300, information for displaying a list of maintenance contractors reflecting the sorting result. Thereby, for example, the user terminal 300 can preferentially display a maintenance contractor close to the desire of the user. For example, the user terminal 300 can display the maintenance contractor close to the desire of the user at the top of the maintenance contractor list.

The user terminal 300 may create reservation information in which priority is set to available work other than the maintenance of the air conditioner 100. The maintenance reservation server 600 preferentially selects a maintenance contractor corresponding to the maintenance contractor information including available work other than the maintenance with high priority, thereby preferentially displaying the selected maintenance contractor on the user terminal 300. The maintenance reservation server 600 assigns a higher weight to available work other than the maintenance with higher priority and calculates a score based on the weight and the number of matches between desired work other than the maintenance included in the reservation information and available work other than the maintenance included in the maintenance contractor information. Thereby, the maintenance reservation server 600 can sort the maintenance contractors according to the score.

As described above, according to the maintenance reservation system in the first embodiment, candidates for the maintenance contractor are selected on the basis of the equipment information and the maintenance contractor information, and the candidates can be narrowed down on the basis of the maintenance contractor information corresponding to the maintenance contractor included in the candidates and the reservation information. Moreover, according to the maintenance reservation system in the first embodiment, it is possible to select candidates on the basis of the equipment information and the maintenance work for the air conditioner 100 included in the maintenance contractor information and narrow down the candidates on the basis of work other than the maintenance corresponding to the maintenance contractor included in the candidates and a request for the work other than the maintenance included in the reservation information. Thereby, according to the maintenance reservation system, a maintenance contractor can be selected according to the user's desire, so that the user's satisfaction with the maintenance can be improved. Moreover, according to the maintenance reservation system, it is possible to support the acquisition of repeat customers by providing work that is a specialty of the maintenance contractor.

Next, a second embodiment will be described.

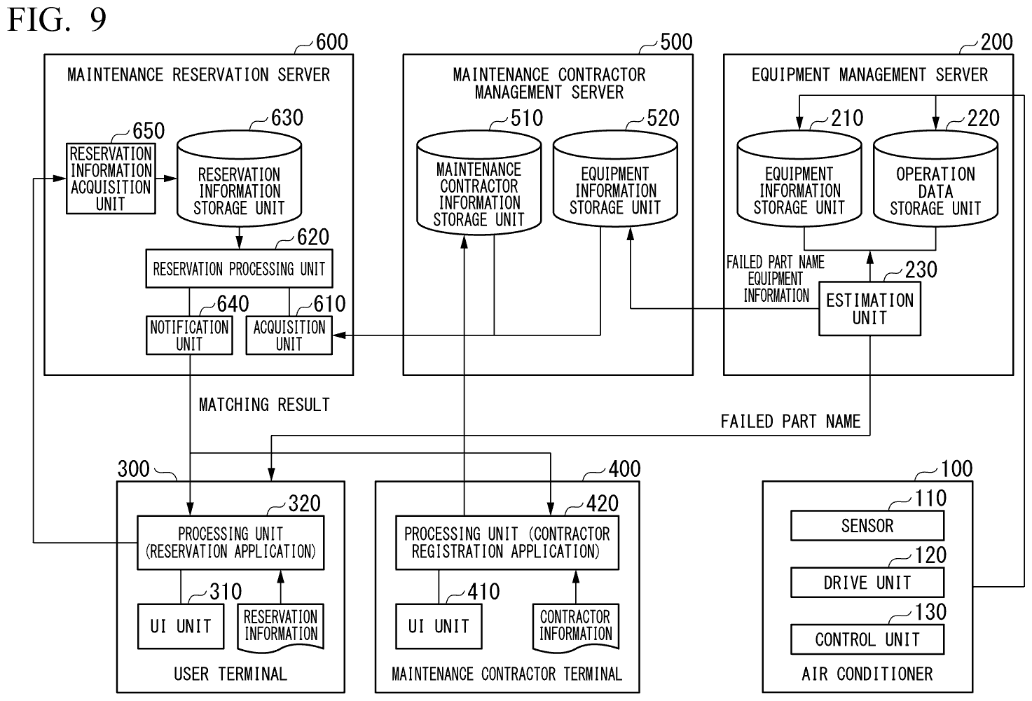

FIG. 9 is a block diagram showing an example of a maintenance reservation system in the second embodiment. The maintenance reservation system in the second embodiment is different from the maintenance reservation system in the first embodiment in that an equipment management server 200 includes an estimation unit 230. Hereinafter, differences will be mainly described.

The estimation unit 230 estimates a failed part of the air conditioner 100 on the basis of information acquired by the air conditioner 100. The estimation unit 230 can estimate a failed part of the air conditioner 100 on the basis of, for example, a model and an error code of the air conditioner 100. In addition to the model and the error code of the air conditioner 100, the estimation unit 230 may estimate the failed part on the basis of operation data, sensor data, or the like. The estimation unit 230 may estimate the failed part on the basis of corresponding relationships among: a past failure or maintenance history stored in the equipment information storage unit 210 and the operation data storage unit 220; equipment information, an error code, and sensor data in the history; and a replacement part in the failure or maintenance history. For example, the estimation unit 230 may train a machine learning model using the failed part as learning data on the basis of corresponding relationships among: the past failure or maintenance history; the equipment information, error code, and sensor data in the history; and the replacement part in the failure or maintenance history. Thereby, when the equipment information, the error code, and the like are acquired from the air conditioner 100, the estimation unit 230 may input the acquired equipment information, error code, and the like to the machine learning model and estimate a failed part on the basis of an output of the machine learning model. The machine learning model may be, for example, a model using a classification method such as a decision tree, a random forest, or LightGBM. The estimation unit 230 transmits to a maintenance contractor server 500, a result of estimating the failed part together with the equipment information.

The maintenance contractor server 500 selects a maintenance contractor on the basis of the failed part estimation result acquired from the equipment management server 200, the equipment information, and the maintenance contractor information. For example, the maintenance contractor server 500 can select a maintenance contractor who has designated the estimated failed part as a priority replacement part or a maintenance contractor who has experience in maintaining the estimated failed part. Thereby, the maintenance contractor server 500 can select a maintenance contractor having strength in repairing or replacing a failed part, so that the user's satisfaction with maintenance can be further improved.

Next, a third embodiment will be described.

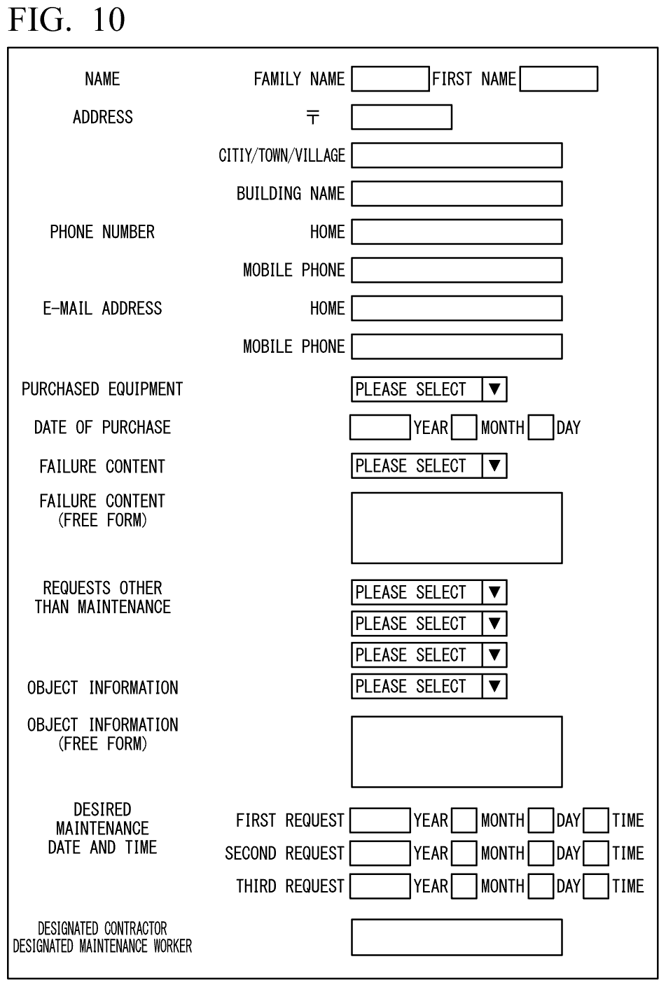

FIG. 10 is a diagram showing an example of a screen for inputting reservation information in the third embodiment. In addition to the screen for inputting the reservation information described in the first embodiment, a field for inputting a maintenance contractor and a maintenance worker designated by the user is provided in the screen for inputting the reservation information. The user terminal 300 receives an operation for inputting a maintenance contractor and a maintenance worker, generates reservation information including designation information of the maintenance contractor and the maintenance worker on the basis of the received operation, and transmits the generated reservation information to the maintenance reservation server 600.

The maintenance reservation server 600 compares the designation information included in the reservation information with candidates for the maintenance contractor selected by the maintenance contractor server 500. When the designated maintenance contractor and maintenance worker are included in the candidates for the maintenance contractor selected by the maintenance contractor server 500, the maintenance reservation server 600 transmits to the user terminal 300, information for notifying that maintenance by the designated maintenance contractor and maintenance worker is available. When the designated maintenance contractor and maintenance worker are not included in the candidates for the maintenance contractor selected by the maintenance contractor server 500, the maintenance reservation server 600 may transmit to the user terminal 300, information for notifying that maintenance by the designated maintenance contractor and maintenance worker is not available.

As described above, according to the maintenance reservation system of the third embodiment, it is possible to receive an operation for designating a maintenance contractor or a maintenance worker from the user, determine whether or not the designated maintenance contractor or maintenance worker is included, and notify the user of a determination result. Thereby, according to the maintenance reservation system, for example, when a maintenance contractor that has been used once wants to be used repeatedly, the maintenance contractor can be designated according to the user's desire, and the user's satisfaction can be further improved. Moreover, the maintenance reservation system can support the acquisition of repeat customers and improve the maintenance contractor's satisfaction.

While the embodiments of the present disclosure have been described above in detail with reference to the drawings, specific configurations are not limited to the above-described embodiments, and other designs and the like may also be made without departing from the scope of the present disclosure. Each configuration described in the above-described embodiments can be arbitrarily combined. For example, the embodiment in which the maintenance service target is the air conditioner 100 has been described, but the present disclosure is not limited thereto. The above-described embodiment may be applied to any other equipment for which a maintenance service is necessary.

1. A maintenance reservation system comprising:
an equipment information acquisition unit configured to acquire equipment information including information about equipment;
a maintenance contractor information acquisition unit configured to acquire maintenance contractor information including information about maintenance contractors who provide maintenance services on the basis of information transmitted from maintenance contractor terminals;
a reservation information acquisition unit configured to acquire reservation information including desired conditions for the maintenance services on the basis of information transmitted from a user terminal;
a processing unit configured to select maintenance contractor candidates on the basis of a model identified with the equipment information and a model within an available range of the maintenance contractors identified with the maintenance contractor information, and narrow down the candidates on the basis of the desired conditions and the maintenance contractor information corresponding to the maintenance contractors included in the candidates; and
a notification unit configured to notify the user terminal of the candidates narrowed down by the processing unit.

2. The maintenance reservation system according to claim 1,
wherein the maintenance contractor information includes information indicating first available work related to maintenance work for the equipment and second available work related to work other than the maintenance of the equipment,
wherein the reservation information includes information indicating a first desired condition related to the maintenance work for the equipment and a second desired condition related to the work other than the maintenance of the equipment, and
wherein the processing unit selects the candidates on the basis of the equipment information, the first available work, and the first desired condition, and narrows down the candidates on the basis of the second desired condition and the second available work corresponding to the maintenance contractors included in the candidates.

3. The maintenance reservation system according to claim 2,
wherein the second desired condition includes priority for the work other than the maintenance of the equipment, and
wherein the processing unit preferentially selects a maintenance contractor corresponding to maintenance contractor information including the second available work matching the work other than the maintenance whose priority is high.

4. The maintenance reservation system according to claim 2,
wherein the first available work includes priority information indicating a part of maintenance or work to be performed by the maintenance contractor in priority, and
wherein the processing unit preferentially selects the maintenance contractor corresponding to the priority information when the first desired condition matches the part of maintenance to be performed by the maintenance contractor in priority.

5. The maintenance reservation system according to claim 2, comprising:
an estimation unit configured to estimate a failed part of the equipment on the basis of the information about the equipment,
wherein the processing unit selects the candidates on the basis of the failed part estimated by the estimation unit and the first available work.

6. The maintenance reservation system according to claim 1,
wherein the reservation information includes designation information for designating the maintenance contractor or a maintenance worker, and
wherein the processing unit determines whether or not the designated maintenance contractor or maintenance worker is included in the candidates when the designation information is included in the reservation information and notifies a user of a determination result.

7. (canceled)

8. A maintenance reservation server comprising:
an acquisition unit configured to acquire information about maintenance contractors who provide maintenance services on the basis of information transmitted from maintenance contractor terminals and reservation information including desired conditions related to work other than maintenance of equipment on the basis of information transmitted from a user terminal;
a processing unit configured to select maintenance contractor candidates on the basis of equipment information including information about the equipment and first available work of the maintenance contractor related to maintenance work for the equipment, and narrow down the candidates on the basis of the desired conditions and second available work of the maintenance contractor related to work other than the maintenance of the equipment; and
a notification unit configured to notify the user terminal of the candidates narrowed down by the processing unit.

9. (canceled)

10. A non-transitory computer-readable storage medium storing a program causing a computer to execute steps of:
acquiring information about maintenance contractors who provide maintenance services on the basis of information transmitted from maintenance contractor terminals and reservation information including desired conditions related to work other than maintenance of equipment on the basis of information transmitted from a user terminal;
selecting maintenance contractor candidates on the basis of equipment information including information about the equipment and first available work of the maintenance contractor related to maintenance work for the equipment, and narrowing down the candidates on the basis of the desired conditions and second available work of the maintenance contractor related to work other than the maintenance of the equipment; and
notifying the user terminal of the candidates narrowed down.

11. The maintenance reservation system according to claim 2,
wherein the reservation information includes designation information for designating the maintenance contractor or a maintenance worker, and
wherein the processing unit determines whether or not the designated maintenance contractor or maintenance worker is included in the candidates when the designation information is included in the reservation information and notifies a user of a determination result.
